(19) United States
(12) Patent Application Publication
(10) Pub. No.: US 2026/0353254 A1
(43) Pub. Date: Nov. 5, 2026

(54) ADVERTISING 60 GIGAHERTZ LINK INFORMATION IN SUB-7 GIGAHERTZ LINKS FOR INTEGRATED MILLIMETER WAVE (IMMW)

(71) Applicant: QUALCOMM Incorporated, San Diego, CA (US)

(72) Inventors: Abhishek Pramod PATIL, San Diego, CA (US); Gaurang NAIK, San Diego, CA (US); George CHERIAN, San Diego, CA (US); Giovanni CHISCI, San Diego, CA (US)

(21) Appl. No.: 19/197,685

(22) Filed: May 2, 2025

(51) Int. Cl. H04W 48/10; H04L 5/00; H04W 72/30; H04W 76/15

(52) U.S. Cl. CPC H04W 48/10; H04L 5/0048; H04W 72/30; H04W 76/15

(57) ABSTRACT

This disclosure provides methods, components, devices and systems for advertising 60 gigahertz link information in sub-7 gigahertz links for integrated millimeter wave (IMMW). Some aspects more specifically relate to advertising 60 GHz link information via advertisement frames of the sub-7 GHz links, or via management of beacon frame periodicities, through multi-link probing operations, or the like. In some examples, the AP may transmit an advertisement frame via the sub-7 GHz links, and the advertisement frame may indicate one or more parameters associated with the 60 GHz link. The AP may include within, the advertisement frame, one or more addresses corresponding to one or more devices such that one or more non-IMMW STAs may refrain from receiving the advertisement frame.

### TECHNICAL FIELD

This disclosure relates generally to wireless communication and, more specifically, to advertising 60 gigahertz link information in sub-7 gigahertz links for integrated millimeter wave (IMMW).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure may be implemented method for wireless communication by a multi-link device (MLD) access point (AP) is described. The method may include communicating one or more first messages to establish a first link with a wireless station (STA), where the first link is an omnidirectional communication link for communication using a first radio access technology, transmitting, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, where the one or more second bands are shared with one or more second radio access technologies that differ from the first radio access technology, and communicating one or more second messages to establish the one or more second links for communication with the STA based on the advertisement frame and the one or more parameters.

Another innovative aspect of the subject matter described in this disclosure can be implemented in a MLD AP for wireless communication is described. The MLD AP may include a processing system that includes processor circuitry and memory circuitry that stores code. The processing system may be configured to cause the MLD AP to communicate one or more first messages to establish a first link with a wireless STA, where the first link is an omnidirectional communication link for communication using a first radio access technology, transmit, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, where the one or more second bands are shared with one or more second radio access technologies that differ from the first radio access technology, and communicate one or more second messages to establish the one or more second links for communication with the STA based on the advertisement frame and the one or more parameters.

Another innovative aspect of the subject matter described in this disclosure can be implemented in a MLD AP for wireless communication is described. The MLD AP may include means for communicating one or more first messages to establish a first link with a wireless STA, where the first link is an omnidirectional communication link for communication using a first radio access technology, means for transmitting, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, where the one or more second bands are shared with one or more second radio access technologies that differ from the first radio access technology, and means for communicating one or more second messages to establish the one or more second links for communication with the STA based on the advertisement frame and the one or more parameters.

Another innovative aspect of the subject matter described in this disclosure can be implemented in a non-transitory computer-readable medium storing code for wireless communication is described. The code may include instructions executable by one or more processors to communicate one or more first messages to establish a first link with a wireless STA, where the first link is an omnidirectional communication link for communication using a first radio access technology, transmit, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, where the one or more second bands are shared with one or more second radio access technologies that differ from the first radio access technology, and communicate one or more second messages to establish the one or more second links for communication with the STA based on the advertisement frame and the one or more parameters.

Some examples of the method, multis, and non-transitory computer-readable medium described herein may further include operations, features, means, or instructions for transmitting, via the first link, an indication of an update of the one or more second links, the indication indicating one or more updated parameters for the one or more second links in accordance with the update or indicating to obtain the one or more updated parameters in accordance with the control information.

Some examples of the method, multis, and non-transitory computer-readable medium described herein may further include operations, features, means, or instructions for transmitting, via the first link, a beacon frame indicating the one or more parameters for the one or more second links or indicating the control information for obtaining the one or more parameters for the one or more second links.

In some examples of the method, multis, and non-transitory computer-readable medium described herein, the beacon frame may be transmitted via the first link based on a size of the beacon frame satisfying a size threshold.

In some examples of the method, multis, and non-transitory computer-readable medium described herein, transmitting the beacon frame may include operations, features, means, or instructions for transmitting the beacon frame that includes one or more target wake time (TWT) elements indicating a TWT schedule for the one or more second links, where the one or more second messages may be communicated based on the TWT schedule.

In some examples of the method, multis, and non-transitory computer-readable medium described herein, the advertisement frame further includes an address indicating at least one of a group address for broadcast communications, an individual address for non-broadcast communications, or a medium access control address of the MLD AP.

In some examples of the method, multis, and non-transitory computer-readable medium described herein, the advertisement frame indicates, via a group address, one or more STAs including the STA for receipt of the advertisement frame.

In some examples of the method, multis, and non-transitory computer-readable medium described herein, the advertisement frame or the one or more parameters for the one or more second links may be transmitted in one or more delivery traffic indication message beacons in accordance with a periodicity and the advertisement frame further indicates the periodicity.

In some examples of the method, multis, and non-transitory computer-readable medium described herein, the periodicity may be in accordance with a first period between each delivery traffic indication message beacon of the one or more delivery traffic indication message beacons or in accordance with a second period between one or more nonconsecutive delivery traffic indication message beacons of the one or more delivery traffic indication message beacons.

Some examples of the method, multis, and non-transitory computer-readable medium described herein may further include operations, features, means, or instructions for receiving, via the first link or one or more third links, one or more request frames in accordance with the advertisement frame and transmitting, via the first link or one or more third links, one or more response frames indicating at least one of the one or more parameters for the one or more second links or indicating one or more TWT elements indicating a TWT schedule for the one or more second links in accordance with the one or more request frames.

Some examples of the method, multis, and non-transitory computer-readable medium described herein may further include operations, features, means, or instructions for transmitting a link setup message including an indication of the first link or the one or more third links.

In some examples of the method, multis, and non-transitory computer-readable medium described herein, the advertisement frame further includes one or more TWT elements indicating a TWT schedule for the one or more second links or one or more elements carrying parameters for the one or more second links.

In some examples of the method, multis, and non-transitory computer-readable medium described herein, the advertisement frame may be transmitted via the first band based on a traffic condition of a second band satisfying a congestion threshold.

In some examples of the method, multis, and non-transitory computer-readable medium described herein, the advertisement frame includes one or more containers, each container of the one or more containers may be indicated in the advertisement frame according to a fixed order, and each of the one or more containers consists of a field, an element, or both.

Some examples of the method, multis, and non-transitory computer-readable medium described herein may further include operations, features, means, or instructions for transmitting a neighbor report or a reduced neighbor report included in the advertisement frame that indicates existence of the one or more second links.

In some examples of the method, multis, and non-transitory computer-readable medium described herein, the advertisement frame includes at least one of a multi-link operation link information element or a basic multi-link element to indicate the one or more second links.

In some examples of the method, multis, and non-transitory computer-readable medium described herein, the advertisement frame includes a message integrity check field or at least a portion of the advertisement frame may be pairwise encrypted.

Some examples of the method, multis, and non-transitory computer-readable medium described herein may further include operations, features, means, or instructions for communicating a beamformed communication via the one or more second links.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example of a signaling diagram that supports advertising 60 gigahertz link information in sub-7 gigahertz links for integrated millimeter wave (IMMW).

FIG. 4 shows an example of a process flow that supports advertising 60 gigahertz link information in sub-7 gigahertz links for IMMW.

FIG. 5 shows a block diagram of an example wireless communication device that supports advertising 60 gigahertz link information in sub-7 gigahertz links for IMMW.

FIGS. 6 through 8 show flowcharts illustrating example processes performable by or at a multi-link device (MLD) AP that supports advertising 60 gigahertz link information in sub-7 gigahertz links for IMMW.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a wireless station (STA) and an access point (AP) may communicate in accordance with multi-link operation (MLO). In some examples, the STA and the AP may communicate via a 60 GHz link, and the STA and the AP may communicate one or more parameters associated with the 60 GHz link (such as 60 GHz management frame signaling) via one or more links having a bandwidth of less than 7 GHz (such as sub-7 GHz, or sub7 GHz links). In such examples, the AP and the STA may communicate the management frame signaling via the sub-7 GHz links to maintain a relatively high-throughput of the 60 GHz for data transmission (such as compared to a 60 GHz link including management signaling). However, communicating the management signaling via the sub-7 GHz links may increase an overhead associated with the management signaling of the sub-7 GHz links (such as beacon bloating), which may similarly increase a latency associated with communications via the sub-7 GHz links, among other examples.

Various aspects relate generally to advertising 60 GHz link information in sub-7 GHz links for IMMW. Some aspects more specifically relate to advertising 60 GHz link information via dedicated advertisement frames of the sub-7 GHz links, or via management of beacon frame periodicities, through multi-link probing operations, or the like. In some examples, the AP may transmit an advertisement frame via the sub-7 GHz links, and the advertisement frame may indicate one or more parameters associated with the 60 GHz link. The AP may include within, the advertisement frame, one or more addresses corresponding to one or more devices (such as IMMW-capable STAs) such that one or more different devices (such as non-IMMW STAs) may refrain from receiving (such as may ignore) the advertisement frame. In some examples, the AP may indicate, via the advertisement frame, one or more links for obtaining the parameters associated with the 60 GHz link (such as according to a multi-link probe scheme), and the AP may indicate one or more updates (such as updated parameters) corresponding to the 60 GHz link via the advertisement frame. Additionally, or alternatively, the AP may transmit, via the sub-7 GHz link, one or more beacon frames indicating the one or more parameters associated with the 60 GHz link. In such examples, the AP may transmit the one or more beacon frames according to a periodicity (such as to reduce beacon bloating).

Particular aspects of the subject matter described in this disclosure can be implemented to realize one or more of the following potential advantages. In some examples, by communicating the 60 GHz management frames via the sub-7 GHz links, the described techniques can be used to achieve a relatively increased throughput of the 60 GHz link for communications between the AP and the STA. Additionally, or alternatively, by communicating the 60 GHz management frames via one or more advertisement frames (such as dedicated advertisement frames) of the sub-7 GHz link, according to a ML probe scheme, or via beacon frames according to the periodicity (such as a periodicity less than each scheduled beacon frame), the AP may reduce a size and an overhead of the sub-7 GHz beacon frame signaling (such as compared to including the 60 GHz management frames in each sub-7 GHz beacon frame), which may correspondingly decrease a latency associated with the management signaling, among other improvements.

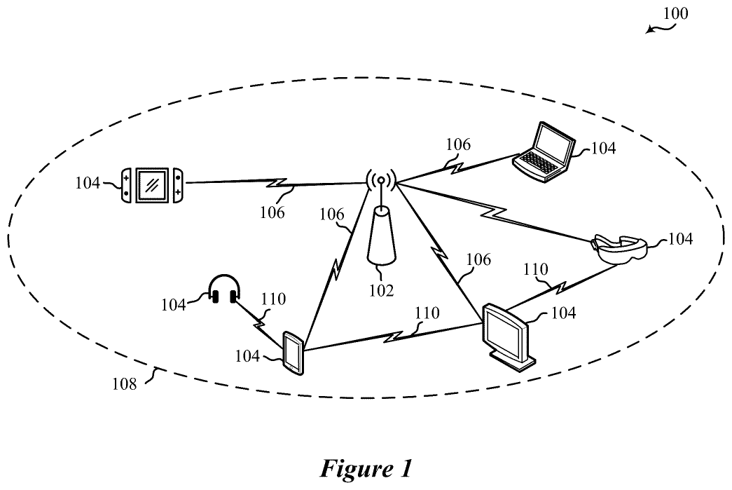

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq IMMW study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (such as a frequency band between 30 GHz and 300 GHz, such as a 60 GHz frequency band). A wireless communication system supporting such mmWave communications (such as AP 102 and STAs 104 in wireless communications network 100) may use integrated mmWave techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub-7 GHz link 305 may be used for management and control information signaling to support the mmWave communications. For example, a STA 104 may first associate with an AP 102 to establish a sub-7 GHz link 305, and thereafter, perform beam searching and training in the mmWave band to establish a mmWave link for the communication of data. In such examples, the sub-7 GHz link 305 may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of MLO. For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

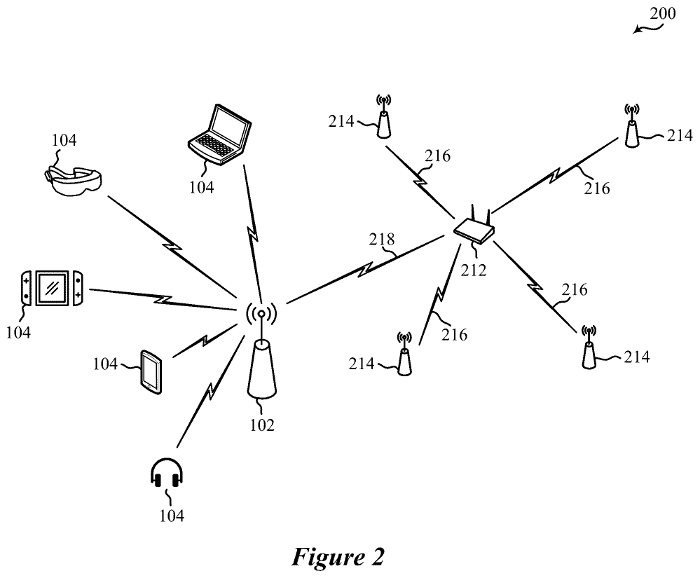

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 102, STAs 104, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

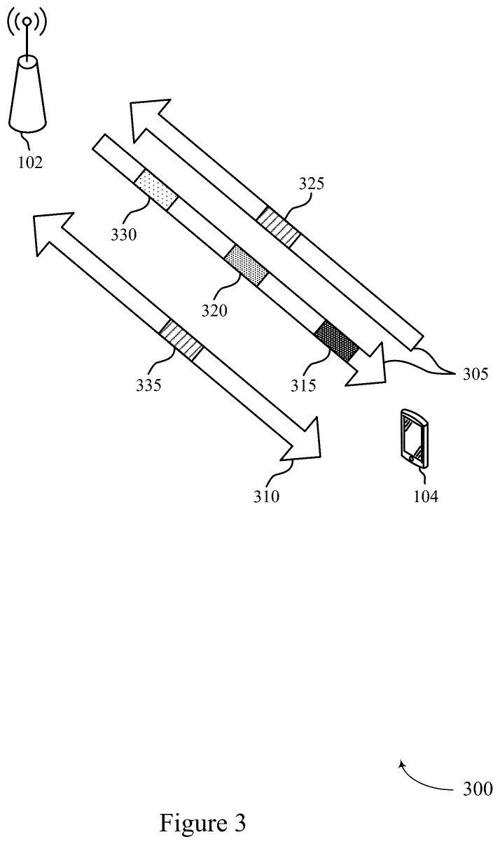

FIG. 3 shows an example of a signaling diagram 300 that supports advertising 60 gigahertz link information in sub-7 gigahertz links for IMMW. Aspects of the signaling diagram 300 may implement or be implemented by aspects of the wireless communication network 100, the wireless communication network 200, or both. For example, the signaling diagram 300 may include an AP 102 and a STA 104.

In some examples, the AP 102 and the STA 104 may communicate one or more beacon frames according to a restricted size, or a restricted set of information (such as a restricted amount of information) included within the beacon frames. For example, the AP 102 may output the beacon frames not including (such as not carrying) one or more capabilities elements or other parameters corresponding to ultra high reliability (UHR) communications, among other examples. The AP 102 may output, via the beacon frames, one or more operation elements indicating limited information (such as a subset of information associated with communication between the AP 102 and the STA 104). For example, the AP 102 may output a bitmap indicating one or more enabled features (such as features of a communication link) without including one or parameters for each feature.

Additionally, or alternatively, the AP 102 may transmit one or more probe frames, association response frames, reassociation response frames, or the like indicating the parameters (such as full parameters) for the enabled features. In some examples, the AP 102 may perform one or more critical updates mechanisms to provide advanced notification of an upcoming update in a beacon frame, and the AP 102 may indicate, via the beacon frames, new parameters for an MLD-level update, an update to the parameters of a transmitting link, or one or more parameters associated with one or more links different from the transmitting link.

In some examples (such as in IMMW designs), the AP 102 may offload management frame signaling to one or more sub-7 GHz links 305 (such as sub-7 GHz links 305, or omnidirectional links). In such examples, the AP 102 and the STA 104 may communicate via a 60 GHz link 310 310 (such as a 60 GHz transmitting link, or a beamformed link) and, by offloading the management frame signaling to the sub-7 GHz links 305, the AP 102 and the STAs 104 may achieve, via the 60 GHz link 310 (such as fat pipe), a high-throughput data link. Accordingly, the AP 102 may indicate, via the sub-7 GHz links 305, information about the 60 GHz link 310 including advertising capabilities, operational parameters, and other attributes of the 60 GHz link 310. Additionally, or alternatively, the AP 102 may perform one or more setups for the 60 GHz link 310 via the sub-7 GHz link 305. However, in such examples, transmitting the management frame signaling via the sub-7 GHz links 305 may increase a size, an overhead, or both (such as put a burden on) management frames of the sub-7 GHz links 305, which may increase beacon bloating, among other examples (such as may exceed the restricted set of information included in the beacon frames). Accordingly, the AP 102 may perform one or more mechanisms for balancing beacon bloat while advertising IMMW information (such as 60 GHz link 310 information) on the sub-7 GHz links 305.

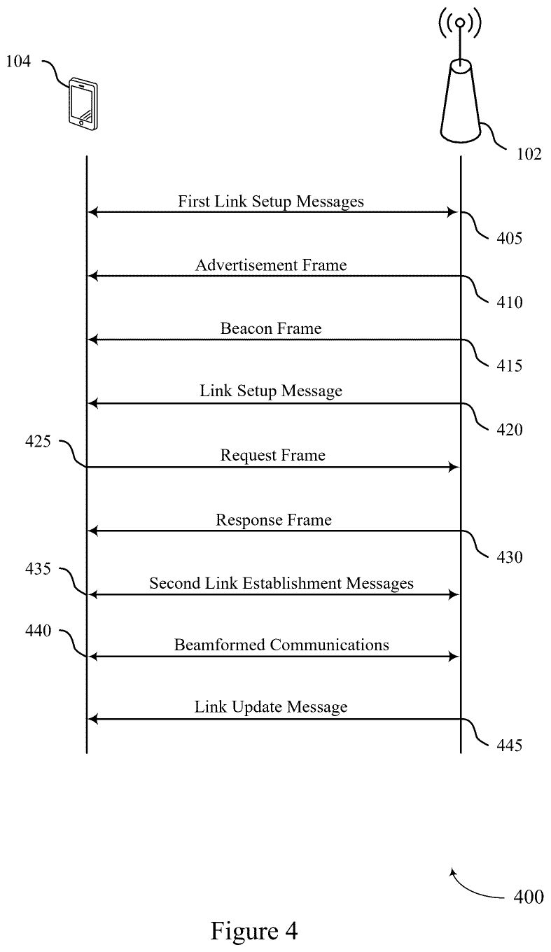

In some examples, the AP 102 may indicate one or more updates to operational parameters or configurations of the 60 GHz link 310 via the sub-7 GHz link 305 as further described herein with reference to FIG. 4. However, the AP 102 may refrain from communicating a beacon frame via the 60 GHz link 310, or the AP 102 may indicate a beacon frame including a reduced set of information (such as light beacon) via the 60 GHz link 310, and the AP 102 may accordingly refrain from indicating the configuration or operational parameters via the 60 GHz link 310. Accordingly, the AP 102 may indicate updates to the transmitting link (such as the 60 GHz link 310), for one or more other links, or both in the beacon frame via the sub-7 GHz link 305 (such as sub7 to provide updates for 60 GHz link 310).

In some examples, the AP 102 may operate according to one or more mechanisms to advertise updates pertaining to 60 GHz link 310 on the sub-7 GHz link 305 (such as without causing beacon bloating on sub7) such that one or more non-IMMW STAs 104 (such as legacy STAs) on sub7 are unaffected by update events (e.g., critical update events). In such examples, the AP 102 may transmit an indication of an IMMW update, and one or more STAs 104 that do not support IMMW (such as or are unaware of the 60 GHz link 310 in their ML setup) may refrain from triggering an update retrieval procedure (such as by aborting estimate by time (EBT) procedures or sending probes).

In some examples, the AP 102 and the STA 104 may communicate according to one or more service periods (SPs) (such as dedicated SPs (D-SP) and on-demand SPs (O-SPs) for scheduled (such as deterministic) communications. In some examples, the AP 102 may, in accordance with deterministic operations, transmit a broadcast target wake time (bTWT) (such as for aperiodic traffic) to multiple STAs 104 or individual TWTs (such as for periodic traffic) based on one or more traffic conditions. In some examples, the AP 102 may, in accordance with one or more on-demand operations SPs, transmit a bTWT. In such examples, the AP 102 may transmit an indication of (such as setup) the TWTs, the bTWT, or both via the sub-7 GHz link 305 (such as both types of TWTs may be set up via sub-7 GHz link 305). In some examples, the AP 102 may indicate a bTWT SP for the 60 GHz link 310 via the sub-7 GHz link 305 (such as advertised on sub-7 GHz link 305 as a broadcast TWT parameter set). Accordingly, the STAs 104 (such as interested STAs) may subscribe to a D-SP, an O-SP (such as for handling a new flow or as supplementary to D-SP), or both.

In some examples, the AP 102 may be unable to indicate (such as via the broadcast TWT parameter set) that one or more TWTs are associated with a different link. For example, the AP 102 may transmit a beacon frame including an indication of a bTWT parameter set corresponding to the 60 GHz link 310 (such as via a TWT information element (IE)) via the sub-7 GHz link 305, and the STAs 104 may attempt to subscribe to a SP indicated by the bTWT. In some examples, the bTWT parameter set includes 9 octets (such as data octets), which may increase beacon bloating. Additionally, or alternatively, an IMMW bTWT schedule (such as indicated by the bTWT parameter set of the beacon frame) may overlap with a bTWT schedule, a restricted TWT (rTWT) schedule, a coordinated rTWT (c-rTWT) schedule, or the like corresponding to the sub-7 GHz link 305 (such as which may lead to confusion and distrust). For example, the AP 102 may transmit the beacon frame including an indication of the bTWT parameter set for the 60 GHz link 310, and the STA 104 may be unable to distinguish between a bTWT schedule for the 60 GHz link 310 and one or more TWT schedules of the sub-7 GHz link 305. Accordingly, the AP 102 may operate according to one or more mechanisms to isolate IMMW bTWT parameters such that STAs on sub-7 GHz link 305 may refrain from detecting the IMMW bTWT parameters, may ignore them, or may discard them.

The techniques, methods, and devices described herein may support advertising 60 gigahertz link information in sub-7 gigahertz links for IMMW. For example, the AP 102 may perform management frame signaling for the 60 GHz link 310 via the sub-7 GHz link 305, which may enable the AP 102 and the STA 104 to achieve a high-throughput for communications via the 60 GHz link 310, among other examples.

In some implementations, the AP 102 may transmit, via the sub-7 GHz link 305 (such as one or more omnidirectional links), an advertisement frame 315 (such as a dedicated frame, which may be referred to as a Multi-Link Information frame, a Link Information frame, a Cross-Link Information frame, an IMMW Information frame, or the like) indicating link information of the 60 GHz link 310. In some examples, the advertisement frame may be a band and feature specific frame that includes an identifier that such frame includes IMMW Information or Advertisement Information, or both. For example, the AP 102 may transmit a beacon frame 320 (such as a sub-7 GHz beacon frame), a non-ML probe response frame, or both via the sub-7 GHz link 305 indicating an existence (such as presence) of the 60 GHz link 310, and the AP 102 may indicate one or more parameters of the 60 GHz link 310 (such as one or more parameters for one or more second links) via the advertisement frame 315. In some examples, the AP 102 may transmit, via the beacon frame 320, a neighbor report (NR), a reduced NR (RNR), or both indicating a subset of parameters (such as rudimentary information) of the 60 GHz link 310.

For example, the advertisement frame 315 may be referred to as a Multi-Link Information (or Advertisement) frame, a Link Information (or Advertisement) frame, a Cross-Link Information (or Advertisement) frame, an IMMW Information (or Advertisement) frame, or the like (such as a band/feature-specific frame may include such identifier in the same).

Additionally, or alternatively, the AP 102 may indicate, via the advertisement frame 315, parameters for one or more constraint links (such as constraint links including links operating on 28, 45 or 3.5 GHz bands), which may include the 60 GHz link 310. A constraint link may refer to a link operating on a band shared with another radio access technology (as is the case for 3.5 GHz band where Wi-Fi needs to vacate the channel when incumbent is using a channel of the 3.5 GHz band) or communication on the band (e.g., 45 or 60 GHz) is possible only when both parties have beams facing each other, or the like, or any combination thereof. For example, the AP 102 may indicate parameters for one or more links shared by two or more technologies (such as access technologies), bands associated with beamformed communication on the band (such as 45 or 60 GHz when both parties have beams facing each other), or both. In such examples, the AP 102 may transmit management information related to the one or more constraint links (such as the 60 GHz link, or beamformed links) via one or more different links where unconstrained transmission may occur (such as sub-7 GHz links including 2.4, 5, or 6 GHz links, or omnidirectional links). The STA 104 (such as a non-AP MLD) may receive the management information via the sub-7 GHz link 305 based on the sub-7 GHz link 305 being included in a multi-link (ML) setup signaling exchange of the STA 104. Additionally, or alternatively, the STA 104 may receive the management information (such as 60 GHz complete profile) via one or more link reconfiguration response frames, one or more association response frames, one or more reassociation response frames, or the like. For example, the STA 104 (e.g., a non-AP MLD) may receive complete information for one or more requested links if those links are part of a multi-link setup. The complete information (e.g., complete profile for the 60 GHz link) may be indicated in one or more of a (re) Association response or a Link Reconfiguration Response frame.

In some implementations, the AP 102 may transmit the advertisement frame 315 that includes a group address (such as broadcast or multicast address), an individual device address (such as individually addressed), or both. For example, the AP 102 may transmit the advertisement frame 315 that includes a broadcast address, and one or more STAs (such as non-IMMW STAs, or legacy STAs) may expect (such as anticipate) such broadcast transmissions to occur during delivery traffic indication message (DTIM) beaconing occasions, as part of DTIM beacons, or both. Accordingly, the AP 102 may transmit the broadcast advertisement frame 315 during each DTIM beacon of a set of DTIM beacons or according to a periodicity during an nth DTIM beacon of the set of DTIM beacons (such as for efficiency). In such examples, the AP 102 may transmit an indication of the periodicity (such as indicating the periodicity or a next occurrence of the advertisement frame 315) via one or more beacon frames, one or more probe response frames, one or more association response frames, one or more reassociation response frames, or the like. Accordingly, the STA 104 (such as IMMW STAs) may determine which DTIM frame may include the broadcast advertisement frame 315.

Additionally, or alternatively, the AP 102 may transmit the advertisement frame 315 that includes a non-broadcast group address. In such examples, the AP 102 may set a bit (such as an I/G bit) of the address of the advertisement frame 315 to indicate an addressing format different than a group address (such as an individual address). In some cases, the advertisement frame 315 may not be sent during every beacon interval and instead may be sent during every nth beacon interval. The AP 102 may provide an indication (e.g., in a Beacon frame, a Probe Response, a (Re) Association Response frame) of how often transmission of the advertisement frame (such as the cross-link information frame) occurs. For example, the AP 102 may transmit the advertisement frame 315 that includes an address (such as a special address associated with IMMW operations or MLO), and the STA 104 may refrain from decoding (such as ignore) the advertisement frame 315 based on the advertisement frame 315 having the address. In some examples, the STA 104 may interpret the advertisement frame 315 as being an individually-addressed frame (such as a frame addressed for a STA different from the STA 104). In some examples, the AP 102 may transmit the advertisement frame 315 according to a MAC address (such as a special MAC address), which may include a MAC address associated with the AP 102. The AP 102 may indicate (such as advertise) the MAC address via one or more beacon frames, one or more probe response frames, one or more association response frames, one or more reassociation response frames, or the like, and the AP 102 may further indicate a periodicity of the advertisement frame 315 (such as how often the AP 102 transmits the cross-link information frame).

In some examples, the AP 102 may transmit the advertisement frame 315 via an Enhanced Broadcast Services (EBCS) content message, which may be correspond to a content identifier (ID) (such as a designated content ID). In such examples, the AP 102 may transmit the advertisement frame 315 that includes a specific receiver group address, and the AP 102 may indicate one or more upcoming frames via an EBCS TIM element (such as instead of a bit in the TIM element). Accordingly, the one or more STAs (such as non-IMMW STAs) may refrain from receiving (such as ignore) the EBCS TIM element and an associated frame with the specific receiver group address.

In some implementations, the AP 102 may transmit the advertisement frame 315 via an action frame, or a public action frame, which may include a field (such as a field or element) indicating one or more links corresponding to the one or more link parameters indicated by the advertisement frame 315 (such as constraint links such as the 60 GHz link 310 for which the information applies). In some examples, the AP 102 may transmit the field via a MLO link information element, which may correspond to one or more individually-addressed management frames, one or more group-addressed management frames (such as more than one link ID bit may be set to 1 if the same information applies to multiple links), or both. In such examples, multiple STAs 104 may receive the MLO link information element.

In some examples, the AP 102 may transmit, via the action frame or public action frame, one or more fields, elements, or both associated with the 60 GHz link 310 (such as intended link(s)), which may further carry parameters for a feature for which there may be an update (such as a critical update). In such examples, the AP 102 may transmit a variable (such as not fixed) quantity of fields or elements (such as a same frame may carry a set of elements for a link or an element set including multiple elements may apply to one or more links). In some examples, the action frame or public action frame may carry one or more fields, one or more elements, or both, for one or more intended link(s). In some examples, the advertisement frame 315 transmitted via an action frame, or a public action frame, may be a single frame that carries a set of elements for a particular link, an element set that applies to more than one link, or both, which provides the ability to carry parameters for a feature for which there is an update (e.g., a critical update).

In some implementations, the AP 102 may transmit the one or more fields (such as containers) according to a fixed order (such as or embedded within an element). Additionally, or alternatively, the AP 102 may transmit one or more elements according to a fixed order, which may be based on one or more element IDs, one or more element ID extensions, or the like, or the order may be predetermined. In some examples, when the AP 102 may transmit a MLO link information element, the AP 102 may transmit the MLO link information element according to a position (such as an element position in a frame) as a beginning element of a frame, a last element of a frame, one or more intermediate elements, or the like. For example, the AP 102 may transmit the MLO link information element as the beginning element of the frame based on transmitting a broadcast message (such as a broadcast advertisement frame 315). In such examples, the STAs 104 may determine, according to the location of the MLO link information element, to which GHz link 310 the information included in the MLO link information element applies.

In some implementations, the AP 102 may transmit the advertisement frame 315 that has integrity protection. For example, the AP 102 may transmit the advertisement frame 315 as a broadcast or group-addressed message including a message integrity check (MIC) field (e.g., a MIC field carried within the Management MIC element (MME)), where the MIC field may be carried in an early portion of the advertisement frame 315. In such examples, the STA 104 may terminate reception of the advertisement frame 315 (such as terminate reception early) based on the MIC field. Additionally, or alternatively, the AP 102 may transmit the advertisement frame 315 (such as individually-addressed frames) according to an encryption (such as pairwise encryption) corresponding to the AP 102 and STA 104 pair. For example, the individually addressed frames (such as advertisement frames) may be encrypted via a pairwise key.

In some implementations, the AP 102 and the STAs 104 may perform, via the advertisement frame 315, one or more update mechanisms (such as critical update mechanisms) for the 60 GHz link 310, which may be independent of one or more updates (such as critical updates) of BSS parameters announced in one or more beacons. In such implementations, the advertisement frame 315 may include (such as carry) a dedicated critical update flag (such as flag or gen update bits) indicating that the advertisement frame 315 is signaling (includes) an update (e.g., critical update).

In some implementations, the AP 102 may indicate, via the advertisement frame 315, or the like, information, such as control information, for multiple links (such as multiple beamformed links including two links on 60 GHz, or a 3.5 GHz link and a 60 GHz link), where a portion of the information may be common to one or more links of the multiple links. For example, the AP 102 may indicate the information, such as control information, for the multiple links when the information for more than one link may be provided and there exists information that is common to those links, among other examples. In some examples, the AP 102 may transmit, via the advertisement frame 315, a basic multi-link (Basic ML) element, where each per-STA profile may correspond to a link for which a specific set of elements apply. The AP 102 may transmit one or more additional elements outside the Basic ML IE (such as carried in the core frame), which may apply to each link of the multiple links (such as are inherited by each link) while elements within each profile may be specific to that link. For example, such schemes may provide the flexibility to carry information (such as common and link-specific information) for multiple links. In some examples, the AP 102 may refrain from transmitting the MLO link information element via the advertisement frame 315 in accordance with transmitting the Basic ML element.

In some examples, the AP 102 may provide an indication (e.g., control information) of which scheme is being followed. For example, the AP 102 may indicate whether the MLO Link Info element (such as all information applies to all links signaled in the MLO Link Info IE) or the Basic ML IE (such as when only portion of the information is common) is communicated. For example, an absence of the MLO Link Info element and a presence of Basic ML IE may provide an implicit indication.

In some implementations, the AP 102 may transmit, via the beacon frame 320 or the non-ML probe response frame, an indication of the existence (such as presence) of the 60 GHz link 310 (e.g., provide 60 GHz link control information or one or more parameters in ML Probe and (Re) Assoc frames sent on sub-7 GHz link). For example, the AP 102 may transmit, via the beacon frame 320, a NR IE, a RNR IE, or both indicating a subset of parameters (such as rudimentary information or control information used by the STA 104 for obtaining one or more parameters for a second link) of the 60 GHz link 310 (such as not including a complete profile for the 60 GHz link 310 in such frames). For example, the AP 102 provide basic configuration of the 60 GHz link 310 (e.g., one or more parameters) and control information regarding which features are enabled for that link without providing the actual parameters for those features. In some examples, the AP 102 may output a bitmap (such as enabled bitmap) indicating one or more currently enabled features of the 60 GHz link 310 without including one or parameters for each feature.

In some examples, the STAs 104 (such as a non-AP device interested in communicating via the 60 GHz link 310) may perform a ML probe to obtain control information associated with the 60 GHz link 310. For example, the STA 104 may perform the multi-link probe to determine the control information for that link (such as the 60 GHz link). For example, the STA 104 may transmit a request frame 325 (such as a ML probe request frame) via the sub-7 GHz link 305 requesting the control information (such as the profile) of the 60 GHz link 310. The STA 104 may transmit the request frame 325 in accordance with receiving the advertisement frame 315, the beacon frame 320, or both, and on the advertisement frame 315 or the beacon frame 320 indicating the existence of the 60 GHz link 310 (such as and including control information used by the STA 104 for obtaining one or more parameters for a second link). Accordingly, the AP 102 may transmit a response frame 330 (such as a ML probe response), which may include the profile of the 60 GHz link 310 or other requested links. For example, the AP 102 may transmit the ML probe response carrying a complete profile for the requested links in the per-STA profile (of the Basic ML IE) corresponding to those links. In some examples, the STA 104 may receive the profile of the 60 GHz link 310 in accordance with the 60 GHz link 310 (such as the requested links) corresponding to the ML setup. For example, the non-AP MLD may receive complete information (e.g., complete set of parameters) for the requested links if those links are part of the multi-link setup. In some examples, the AP 102 may transmit one or more association response frames, reassociation response frames, or link reconfiguration response frames including the profile for the 60 GHz link 310

In some implementations, the AP 102 may transmit, via the beacon frame 320, the information of the 60 GHz link 310 (such as provide 60 GHz link information in beacon frame sent on sub-7 link). For example, the AP 102 may include the profile (such as complete information) corresponding to the 60 GHz link 310 in a per-STA profile of a Basic ML IE carried in the beacon frame 320. In some examples, the AP 102 may transmit the profile corresponding to the 60 GHz link 310 according to a periodicity, or a cadence (such as not each beacon frame, or each 5th beacon frame to limit beacon bloating). For example, the information is not carried in every beacon. For example, the AP 102 may transmit the profile during a DTIM beacon, or the nth DTIM beacon, and other beacons (and non-ML probes) may provide rudimentary information of 60 GHz link 310 (such as via fields in RNR IE). The AP 102 may transmit an indication (such as advertise, via a field of the beacon frame 320) of the cadence such that the STA 104 may determine when to expect the information. In some examples, the STA 104 may determine, in accordance with the cadence, whether to wait to receive the beacon frame 320 including the profile, or to transmit the request frame 325 (such as based on a wait time for the profile). For example, the non-AP may determine to wait for the beacon carrying the information or to send a probe based on how long the non-AP may wait. The AP 102 may transmit the information of the 60 GHz link 310 via the beacon frame 320 in accordance with a size of the beacon frame satisfying a threshold size (such as a threshold beacon bloating).

In some implementations, the AP 102 may transmit the information of the 60 GHz link 310 via one or more sub-7 GHz links 305 (such as the 60 GHz information is provided only on certain sub-7 links, or some omnidirectional links). For example, a 2.4 GHz link may be crowded or congested, or a beacon frame of the 2.4 GHz link may be bloated, and the 60 GHz information is not provided on the 2.4 GHz link accordingly. The AP 102 may instead transmit the indication of the presence of the 60 GHz link 310 (such as rudimentary information as affiliated with the MLD) via a beacon frame, a probe response frame, an association response frame, a reassociation response frame, or the like via the 2.4 GHz link. In some examples, the AP 102 may transmit the profile of the 60 GHz link 310 via one or more sub-7 GHz links 305 different from the 2.4 GHz link (such as a 5 GHz link, or a 6 GHz link) in accordance with the 2.4 GHz link being crowded or congested, or in accordance with the beacon frame on the 2.4 GHz link being bloated (such as then the 60 GHz information is not provided on 2.4 GHz), and the AP 102 may indicate the different sub-7 GHz links via the frame of the 2.4 GHz link. For example, the AP 102 may transmit a beacon frame, or probe response frame, or association response frame, or association response frame via the 2.4 GHz link that indicates the presence of 60 GHz AP (such as affiliated with the MLD) and may point to the other sub-7 GHz links 305 (such as 5/6 GHz) where additional details of 60 GHz link 610 may be found.

For example, the AP 102 may transmit the indication of the presence of the 60 GHz link 310 and may indicate which sub-7 links via which the AP 102 may provide the information of the 60 GHz link 310. Additionally, or alternatively, the AP 102 may indicate the sub-7 GHz links 305 as a global setting (such as applies to multiple STAs) or corresponding to a subset of sub-7 GHz links 305 that may be part of the STA 104 ML setup (such as a per-STA setting) and according to a congestion of other sub-7 GHz links 305 (such as the 2.4 GHz link). For example, the AP 102 may indicate the sub-7 GHz links 305 as a global setting (such as applies to all STAs) or based on which sub-7 links may be part of the non-APs ML setup and how congested other links are. The STA 104 may utilize any link (such as any sub-7 GHz link) based on an absence of the global setting (such as in the non-AP ML setup). For example, if the global links are not part of the non-APs ML setup, the AP 102 may communicate (such as and the STA 104 may expect to receive) the information of the 60 GHz link via any of the sub-7 GHz links 305.

In some implementations, the AP 102 may transmit the information of the 60 GHz link 310 via (such as the detailed information (parameters, etc.) may be carried in) one or more elements (such as separate elements) including IMMW configuration elements or IMMW capabilities elements (such as for carrying static information and supported features), or IMMW operation elements (such as for carrying dynamic information including enabled features and other operational parameters). The AP 102 may transmit the elements via the dedicated frame (such as the advertisement frame 315), or via a STA profile field of a per-STA profile subelement of the Basic ML IE. In some examples, the AP 102 may transmit an indication of static configuration information of the 60 GHz link 310 via one or more fields of a STA control field or a STA information field of the per-STA profile subelement. For example, some of the static configuration information may be included by repurposing fields in the STA Control and STA Info fields of the Per-STA Profile subelement of the Basic ML IE corresponding to a reported 60 GHz link 310. In such examples, the AP 102 may transmit one or more additional elements to indicate (such as signal) parameters associated with the indicated features (such as enabled features).

In some implementations, the AP 102 may transmit an indication of one or more parameters corresponding to the information of the 60 GHz link 310 including a BSSID (such as MAC address) of 6 octets or 48 bits, a beacon interval (BI) for the 60 GHz link 310 indicated by 2 octets or 16 bits, a timing synchronization function (TSF) Offset indicated by 8 octets or 64 bits, an AP sector reference (ASR) transmission period (ATP) periodicity indicated by 4 bits (such as a multiple of the BI of 60 GHz link of up to 16×BI), a quantity of sectors indicated by 8 bits (such as signaling up to 255 sectors), a dwell time per sector indicated by 4 bits (such as signaling up to 16 microseconds (μs) of dwell time), a next ATP TSF indicated by 2 octets (such as signaling lower two octets of the 60 GHz TSF), or the like.

In some implementations, the AP 102 and the STA 104 may communicate one or more messages 335 via the 60 GHz link 310, which may include directional communication (such as high directionality of the 60 GHz link 310). In some examples, the AP 102 and the STAs 104 may communicate the one or more messages 335 via beamformed communications. For example, since communication on 60 GHz link 310 is highly directionally, the 60 GHz link 310 may not be used for transmitted group addressed frames, and the DTIM fields may be repurposed. Accordingly, the AP 102 may refrain from transmitting one or more group-addressed frames via the 60 GHz link 310, and the AP 102 may utilize (such as repurpose) one or more DTIM frames of the 60 GHz link 310 for different communications. Additionally, or alternatively, the AP 102 and the STA 104 may refrain from performing non-simultaneous transmit and receive (NSTR) operations via the 60 GHz link 310 (such as NSTR properties may not apply for 60 GHz), may refrain from performing extremely high throughput (EHT) BSS parameter change count (BPCC) operations via the 60 GHz link 310 (such as EHT BPCC may not apply for 60 GHz), or both. Accordingly, the AP 102 may utilize one or more DTIM information fields, one or more NSTR information fields, or one or more BPCC information fields of a STA control field format or a STA information field format for the different communications via the 60 GHz link 310, and the AP 102 may utilize one or more reserved bits of the STA control field format for 60 GHz BPCC, among other examples. For example, four reserved bits of STA Control may be repurposed for 60 GHz BPCC by the AP 102 and the STA 104. The STA control field format and the STA information field format are respectively shown in Table 1 and Table 2 below.

TABLE 1
STA Control Field Format of the Basic Multi-Link Element

| | | | | | | | | B11 | |
|---|---|---|---|---|---|---|---|---|---|
| | | B5 | | | | B9 | | BSS | |
| | | STA | B6 | B7 | B8 | NSTR | B10 | Parameters | |
| B0-B3 | B4 | MAC | Beacon | TSF | DTIM | Link | NSTR | Change | |
| Link | Complete | Address | Interval | Offset | Info | Pair | Bitmap | count | B12-B15 |
| ID | Profile | Present | Present | Present | Present | Present | Size | Present | Reserved |
| Bits: 4 | 1 | 1 | 1 | 1 | 1 | 1 | 1 | 1 | 4 |

TABLE 2
STA Information Field Format of the Basic Multi-Link Element

| | | | | | | BSS |
|---|---|---|---|---|---|---|
| STA | STA | | | | NSTR | Parameter |
| Info | MAC | Beacon | TSF | DTIM | Indication | Change |
| Length | Address | Interval | Offset | Info | Bitmap | Count |
| Octets: 1 | 0 or 6 | 0 or 2 | 0 or 8 | 0 or 2 | 0 or 1 or 2 | 0 or 1 |

### Table 2: STA Information Field Format of the Basic Multi-Link Element

In some implementations, the AP 102 may communicate the information of the 60 GHz link 310, or indicate the existence of the 60 GHz link 310 (such as including the rudimentary information of the 60 GHz link 310) via one or more information portions of one or more fields shown in Tables 3-13 below. For example, the AP 102 may transmit an indication of the rudimentary information of the 60 GHz link 310 via the NR or the RNR respectively shown in Table 3 and Table 4 below.

TABLE 3
Reduced Neighbor Report Element Format

| Element ID | Length | Neighbor AP Information Field |
|---|---|---|
| Octets: 1 | 1 | Variable |

TABLE 4
Neighbor AP Information Field Format

| TBTT Information | Operating | | TBTT Information |
|---|---|---|---|
| Header | Class | Channel Number | Set |
| Octets: 2 | 1 | 1 | Variable |

TABLE 5
TBTT Information Field Format

| Neighbor | | | BSS | 20 | MLD |
|---|---|---|---|---|---|
| AP TBTT | BSSID | Short SSID | Param- | MHz | Param- |
| Offset | (optional) | (optional) | eters | PSD | eters |
| Octets: 1 | 0 or 6 | 0 or 4 | 0 or 1 | 0 or 1 | 0 or 3 |

TABLE 6
TBTT Information Header Subfield Format

| B0-B1 | B2 | | B4-B7 | B8-B15 |
|---|---|---|---|---|
| TBTT | Filtered | | TBTT | TBTT |
| Information | Neighbor | B3 | Information | Information |
| Field Type | AP | Reserved | Count | Length |
| Bits: 2 | 1 | 1 | 4 | 8 |

TABLE 7
BSS Parameters Subfield Format

| | | | | | B5 | | |
|---|---|---|---|---|---|---|---|
| | | | | | Unsolicited | | |
| B0 | B1 | B2 | B3 | B4 | Probe | B6 | |
| OCT | Same | Multiple | Transmitted | ESS | Response | Colocated | B7 |
| Recommended | SSID | BSSID | BSSID | Member | Active | AP | Reserved |
| Bits: 1 | 1 | 1 | 1 | 1 | 1 | 1 | 1 |

TABLE 8

| | | B12-B19 | | | |
|---|---|---|---|---|---|
| | | BSS | B20 | B21 | |
| | | Parameters | All | Disabled | |
| B0-B7 | B6-B11 | Change | Updates | Link | B22-B23 |
| AP MLD ID | Link ID | Count | Included | Direction | Reserved |
| Bits: 8 | 4 | 8 | 1 | 1 | 2 |

TABLE 9
Neighbor Report Element Format

| | | | BSS | Operating | Channel | PHY | Optional |
|---|---|---|---|---|---|---|---|
| Element ID | Length | BSSID | Information | Class | Number | Type | Subelements |
| Octets: 1 | 1 | 6 | 4 | 1 | 1 | 1 | Variable |

TABLE 10
Neighbor Report Element Format Part 1

| B-B1 | | B3 | | B10 | B11 | B12 | |
|---|---|---|---|---|---|---|---|
| AP | B2 | Key | B4-B9 | Mobility | High | Very High | B13 |
| Reachability | Security | Scope | Capabilities | Domain | Throughput | Throughput | FTM |
| Bits: 2 | 1 | 1 | 6 | 1 | 1 | 1 | 1 |

TABLE 11
Neighbor Report Element Format Part 2

| | | | B17 | | | | |
|---|---|---|---|---|---|---|---|
| | | | Unsolicited | | B19 | B20 | |
| B14 | B15 | B16 | Probe | B18 | OCT Supported | Colocated | |
| High | ER | Colocated | Responses | ESS | With Reporting | With 6 | B21 |
| Efficiency | BSS | AP | Active | Member | AP | GHz AP | Reserved |
| Bits: 1 | 1 | 1 | 1 | 1 | 1 | 1 | 1 |

TABLE 12
Neighbor Report Element Format Part 3

| B22 | B23-B31 |
|---|---|
| DMG Positioning | Reserved |
| Bits: 1 | 9 |

In some examples, the AP 102 and the STA 104 may perform beamformed communications via the 60 GHz link 310 (such as a beamformed link) based on establishing the 60 GHz link 310 via the sub-7 GHz link (such as one or more omnidirectional links).

Particular aspects of the subject matter described in this disclosure can be implemented to realize one or more of the following potential advantages. In some examples, by communicating advertisement frame 315, the beacon frame 320, or both via the sub-7 GHz links 305, the described techniques can be used to achieve a relatively increased throughput of the 60 GHz link 310 for communications between the AP 102 and the STA 104. Additionally, or alternatively, by communicating the information of the 60 GHz link 310 via the beacon frame 320, the advertisement frame 315, or according to a ML probe scheme, the AP may reduce a size and an overhead of the sub-7 GHz beacon frame signaling, which may correspondingly decrease a latency associated with the management signaling, among other improvements.

FIG. 4 shows an example of a process flow 400 that supports advertising 60 gigahertz link information in sub-7 gigahertz links for IMMW. Aspects of the process flow 400 may implement or be implemented by aspects of one or more of the wireless communication network 100, the wireless communication network 200, or the signaling diagram 300. For example, the process flow 400 may include an AP 102 and a STA 104.

In the following description of the process flow 400, the operations between the AP 102 and the STA 104 may be performed in different orders or at different times. Some operations also may be left out of the process flow 400, or other operations may be added. Although the AP 102 and the STA 104 are shown performing the operations of the process flow 400, some aspects of some operations also may be performed by one or more other wireless devices.

At 405, the AP 102 and the STA 104 may communicate one or more first messages (such as first link setup messages) to establish a first link (such as a sub-7 GHz link). In some examples, the first link may include an omnidirectional link associated with a first RAT, and the AP 102 and the STA 104 may perform communications via the omnidirectional link.

At 410, the STAs 104 may transmit, and the STA 104 may receive, via the first link, an advertisement frame, which may be further described herein with reference to FIG. 3. In some examples, the AP 102 may indicate, via the advertisement frame, an existence of one or more second links (such as constraint links, or a 60 GHz link), one or more parameters corresponding to the second links, or control information for obtaining the one or more parameters via a ML probe operation. The one or more parameters may be included in one or more fields, one or more elements, one or more information elements, or the like, or any combination thereof, as described herein. In some cases, the advertisement frame may indicate the existence of the second link, and may include control information (e.g., rudimentary information, a basic configuration, etc.) for obtaining the one or more parameters, such as via a ML probe, via a (re) association frame, or the like, as discussed herein, to obtain the one or more parameters (e.g., obtain a complete profile that includes parameters of a second link).

In some examples, the one or more second links may operate on one or more second bands different from a first band of the first link, and the second bands may be shared with one or more second RATs. In some examples, at 415, the STAs 104 may transmit, via the first link, a beacon frame indicating the parameters of the advertisement frame of 410. The AP 102 may transmit the beacon frame via the first link in accordance with a size of the beacon frame satisfying a threshold size of the beacon frame.

In some examples, at 420, the AP 102 may transmit, via the first link, a link setup message, one or more links of a ML probe operation, which may include the first link, one or more third links (such as additional sub-7 GHz links), or both. In some examples, at 425, the STA 104 may transmit, and the AP 102 may receive, a request frame (such as a ML probe request) requesting the one or more parameters for the one or more second links. For example, the AP 102 may transmit an indication of the existence one or more second links via the advertisement frame of 410, the beacon frame of 415, or both, and the STA 104 may transmit the request frame in accordance with the indication of the existence of the one or more second frames and in accordance with the ML probe operation.

In some examples, at 430, the AP 102 may transmit a response frame (such as a ML probe response) including the one or more parameters of the one or more second links (such as second link profiles, or profiles of the 60 GHz link). The AP 102 may transmit the response frame in accordance with the request frame and in accordance with the ML probe operation. In some examples, the AP 102 may transmit the response frame via an advertisement frame, a beacon frame, or one or more additional frame types, which is further described herein with reference to FIG. 2.

At 435, the AP 102 and the STA 104 may communicate one or more second messages (such as second link establishment messages) to establish the second link and, in some examples, at 440, the AP 102 and the STA 104 may perform communications via the second link, which may include beamformed communications, among other examples. In some examples, the AP 102 and the STA 104 communicate the one or more second messages, perform communications, or both in accordance with the advertisement frame of 405, the beacon frame of 410, the one or more parameters of the one or more second bands, or the like.

In some examples, at 445, the AP 102 may transmit, and the STA 104 may receive, a link update message including an indication of an update of the one or more second links. For example, one or more parameters of the one or more second links may change, and the AP 102 may transmit, via the link update message, the one or more updated parameters for the one or more second links (such as the 60 GHz link) in accordance with the update, or may transmit information to obtain the one or more updated parameters.

In some implementations, the AP 102 may transmit the link update message via a beacon frame of the first link (such as a sub-7 GHz beacon frame), and a field of the beacon frame may indicate the update for the 60 GHz (such as a field in the sub-7 AP beacon indicates that an update for 60 GHz link has occurred). For example, the AP 102 may transmit one field (such as a dedicated bit field) or multiple fields, and a value of the one field (such as 1=update occurred, 0=no update) or a value of a combination of fields of the multiple fields (such as the update type (or gen update) field set to value 2) may indicate the presence of the update. The AP 102 may include the field in an early portion of the beacon frame (such as a Capability Information field), or a bit or a combination of bits in the TIM element (such as bits in the partial virtual bitmap field), or bit or field in the Country element (such as defining a new value for an Operating Class field in the Country element).

In some examples, the AP 102 may transmit an indication of a BPCC of the 60 GHz link via a TBTT Information field corresponding to a reported 60 GHz AP (such as the AP 102) in a RNR element, which is further described herein with reference to FIG. 3. Additionally, or alternatively, the AP 102 may include a field (such as similar to the TBTT information field) in a Basic ML IE in a per STA profile field, and the AP 102 may provide a value of the field via an association response frame, a reassociation response frame, or both (such as since RNR IE may not be included in such frames). Accordingly, a non-AP STA (such as non-IMMW STA) or a STA that is not IMMW capable or does not have a 60 GHz link as part of a corresponding ML setup may ignore (such as not react to) the update.

In some implementations, the AP 102 may transmit an advertisement frame (such as a dedicated frame for carrying 60 GHz information further described herein with reference to FIG. 3) including the updated parameters. For example, updates may be included in the dedicated frame defined for carrying 60 GHz information. In such implementations, the AP 102 may transmit the advertisement frame according to a frequency (such as a periodicity, or a cadence) in accordance with whether an update occurs. For example, the AP 102 may transmit the advertisement frame according to a first frequency prior to the update, and the AP 102 may transmit the advertisement frame according to a second frequency (such as the frequency of the frame may be increased) when an update occurs. Accordingly, the STA 104 (such as non-AP) may quickly determine the updates.

Additionally, or alternatively, the AP 102 may transmit the updated parameters via a beacon frame of the first link (such as a sub-7 beacon frame). In some examples, the AP 102 may transmit the updated parameters via the sub-7 beacon in accordance with the threshold beacon size (such as if sub-7 beacon size is reasonable, or not too bloated, or less than 1,800 bytes). The AP 102 may include the updated parameters via a per-STA profile of the Basic ML IE corresponding to the 60 GHz link. In some examples, the AP 102 may include the updates (such as included uptilt) within a DTIM beacon of the sub-7 GHz link. In such examples, the AP 102 may set a value of a flag to indicate the updates (such as an all updates included (AUI) flag of a RNR set to 1).

In some examples, the sub-7 beacon may be close to bloating (such as near or above a threshold size, or 1,800 bytes), and the AP 102 may correspondingly transmit an indication of the updates (such as does not include the updated parameters) via the sub-7. Accordingly, the AP 102 may set the value of the flag based on the absence of the updated parameters (such as AUI field set to 0), and the STA 104 (non-AP) may perform an ML probe to retrieve the latest parameter set for the 60 GHz link (such as the updated parameters). The AP 102 may respond with a broadcast probe response frame to such a request such that multiple non-AP STAs may receive the updated parameters (such as may be satisfied) and may suppress requests for the parameters (such as preventing probe storm when there is an update for 60 GHz). For example, the AP 102 and the STA 104 may communicate the request frame of 425 and the response frame of 430 based on the indication of the update to obtain the updated parameters.

In some implementations, the AP 102 may indicate via a broadcast frame (such as beacon frame) or via an individually-addressed frame (such as a (re) association response frame) during ML setup, one or more sub-7 GHz links associated with the ML probe operation (such as which sub7 link(s) a non-AP may use (to probe) to retrieve updates for 60 GHz). For example, the AP MLD may, during multi-link setup, indicate which sub-7 links a non-AP may use to probe to retrieve updates for the 60 GHz link. For example, the AP 102 may transmit the link setup message of 420. Additionally, or alternatively, the AP 102 may indicate the sub-7 GHz links as a global setting (such as applies to multiple STAs) or corresponding to a subset of sub-7 GHz links that may be part of the STA 104 ML setup and according to a congestion of other sub-7 GHz links. For example, the AP 102 may indicate the sub-7 GHz links as a global setting (such as applies to all STAs) or based on which sub-7 links may be part of the non-APs ML setup and how congested other links are. The STA 104 may utilize any link (such as any sub-7 GHz link) based on an absence of the global setting (such as in the non-AP ML setup). For example, if the global links are not part of the non-APs ML setup, the non-AP may be free to use any link to send a probe to retrieve the updates. Additionally, or alternatively, the AP 102 may further indicate whether updates (such as critical updates) for the 60 GHz link may be provided in an unsolicited manner (such as in beacon frames, dedicated frames or broadcast probe responses) absent a request from the STA 104. For example, the STA 104 may determine if the STA 104 may receive updates, and via which link to receive the updates (such as without sending a probe request) in accordance with the indication from the AP 102.

In some implementations, the AP 102 may transmit one or more TWT elements via the dedicated frame (such as in the advertisement frame), which may indicate a bTWT schedule of the 60 GHz link (such as a communication schedule of the 60 GHz link). For example, the TWT element carried in the dedicated frame provides the b-TWT schedule of 60 GHz link. In such implementations, non-IMMW STAs (such as legacy STAs) may refrain from attempting to subscribe to the bTWT schedule (such as unaffected). For example, since the frame is ignored by non-IMMW (such as legacy) STAs, the non-IMMW STAs may be unaffected (such as may not attempt to subscribe) to the B-TWT schedules. Additionally, or alternatively, the AP 102 may transmit one or more bTWT parameters for the 60 GHz link via a management frame. The management frame may be a beacon probe frame, a probe response frame, an association response frame, a reassociation response frame (such as a new management frame), a new management frame, or the like. The frame may include a Basic ML IE, and the TWT information may be carried within the per-STA profile of the Basic ML IE corresponding to the 60 GHz link. The AP 102 may further indicate one or more updates to the bTWT parameter set via one or more techniques described herein. For example, bTWT parameters for 60 GHz link may be provided in probe and (re) association response frames within the per-STA profile (of the Basic ML IE) corresponding to the 60 GHz link if there is an update to any of the bTWT parameter set.

In some examples, the AP 102 may transmit the bTWT parameters via a sub-7 beacon frame in accordance with the size of the beacon frame (such as if the sub-7 beacon size is reasonable, or not too bloated). For example, the AP 102 may transmit the bTWT parameters within the per-STA profile of the Basic ML IE corresponding to the 60 GHz link. Additionally, or alternatively, the AP 102 may transmit the bTWT parameter set for IMMW via a TWT IE in the beacon frame (such as the sub-7 beacon frame), and the AP 102 may set a value of one or more fields of the TWT IE such that non-IMMW STAs (such as legacy STAs) may ignore the TWT IE (such as a Broadcast TWT Recommendation field set to 5). The AP 102 may transmit the bTWT parameters according to a periodicity (such as frequency, or cadence) such that the bTWT parameters may be included in a portion of beacon frames (such as not included in each beacon, or each nth beacon, or the DTIM beacons, or each nth DTIM beacon).

Particular aspects of the subject matter described in this disclosure can be implemented to realize one or more of the following potential advantages. In some examples, by communicating advertisement frame, the beacon frame, or both via the sub-7 GHz links, the described techniques can be used to achieve a relatively increased throughput of the 60 GHz link for communications between the AP 102 and the STA 104. Additionally, or alternatively, by communicating the information of the 60 GHz link via the beacon frame, the advertisement frame, or according to the ML probe scheme, the AP may reduce a size and an overhead of the sub-7 GHz beacon frame signaling, which may correspondingly decrease a latency associated with the management signaling, among other improvements.

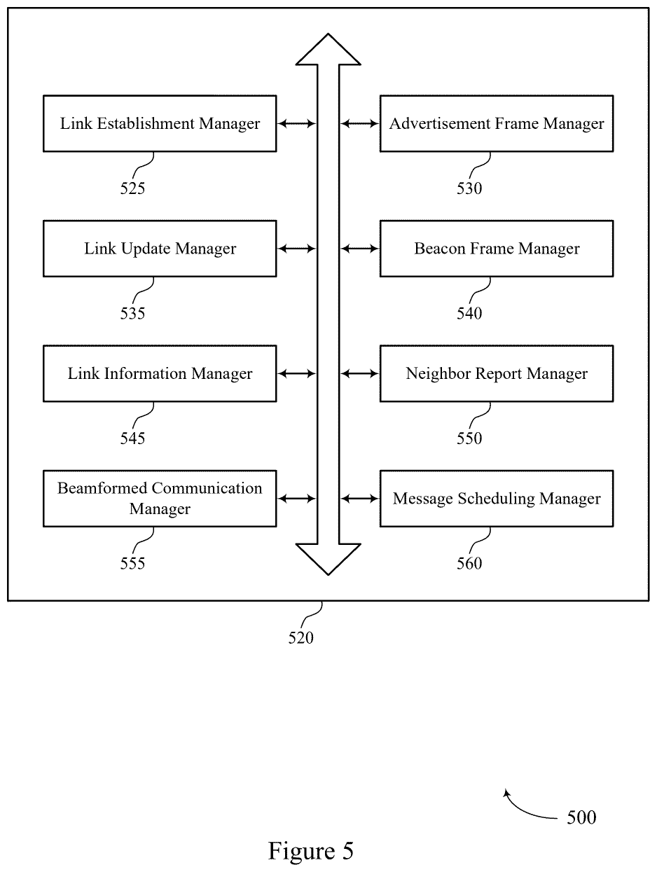

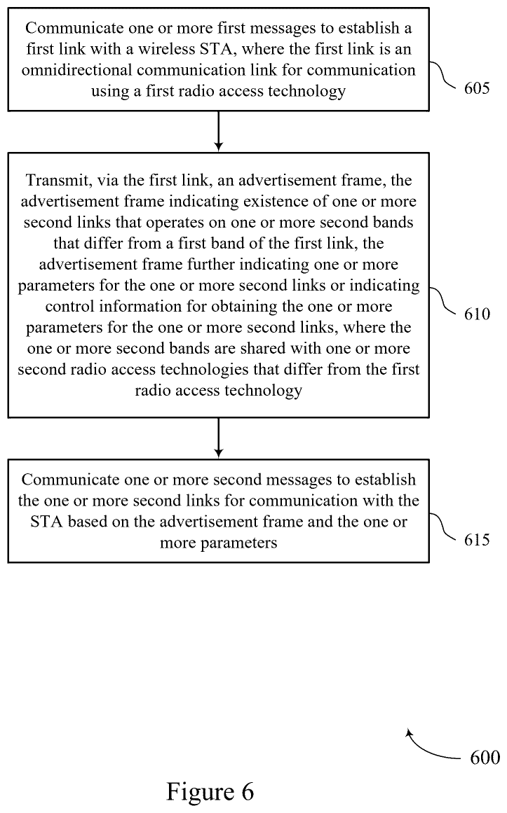

FIG. 5 shows a block diagram 520 of an example wireless communication device 500 that supports advertising 60 gigahertz link information in sub-7 gigahertz links for IMMW. In some examples, the wireless communication device 500 is configured to perform the processes 600, 700, and 800 described with reference to FIGS. 6, 7, and 8, respectively. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in an AP, such as the AP 102 described with reference to FIG. 1. In some other examples, the wireless communication device 500 can be an AP that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes at least one external network interface coupled with the processing system that enables communication with a core network or backhaul network that enables the wireless communication device 500 to gain access to external networks including the Internet.

The wireless communication device 500 includes a link establishment manager 525, an advertisement frame manager 530, a link update manager 535, a beacon frame manager 540, a link information manager 545, a neighbor report manager 550, a beamformed communication manager 555, and a message scheduling manager 560. Portions of one or more of the link establishment manager 525, the advertisement frame manager 530, the link update manager 535, the beacon frame manager 540, the link information manager 545, the neighbor report manager 550, the beamformed communication manager 555, and the message scheduling manager 560 may be implemented at least in part in hardware or firmware. For example, one or more of the link establishment manager 525, the advertisement frame manager 530, the link update manager 535, the beacon frame manager 540, the link information manager 545, the neighbor report manager 550, the beamformed communication manager 555, and the message scheduling manager 560 may be implemented at least in part by at least a processor or a modem. In some examples, portions of one or more of the link establishment manager 525, the advertisement frame manager 530, the link update manager 535, the beacon frame manager 540, the link information manager 545, the neighbor report manager 550, the beamformed communication manager 555, and the message scheduling manager 560 may be implemented at least in part by a processor and software in the form of processor-executable code stored in memory.

The wireless communication device 500 may support wireless communication in accordance with examples as disclosed herein. The link establishment manager 525 is configurable or configured to communicate one or more first messages to establish a first link with a wireless station (STA), where the first link is an omnidirectional communication link for communication using a first radio access technology. The advertisement frame manager 530 is configurable or configured to transmit, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, where the one or more second bands are shared with one or more second radio access technologies that differ from the first radio access technology. In some examples, the link establishment manager 525 is configurable or configured to communicate one or more second messages to establish the one or more second links for communication with the STA based on the advertisement frame and the one or more parameters.

In some examples, the link update manager 535 is configurable or configured to transmit, via the first link, an indication of an update of the one or more second links, the indication indicating one or more updated parameters for the one or more second links in accordance with the update or indicating to obtain the one or more updated parameters in accordance with the control information.

In some examples, the beacon frame manager 540 is configurable or configured to transmit, via the first link, a beacon frame indicating the one or more parameters for the one or more second links or indicating the control information for obtaining the one or more parameters for the one or more second links.

In some examples, the beacon frame is transmitted via the first link based on a size of the beacon frame satisfying a size threshold.

In some examples, to support transmitting the beacon frame, the message scheduling manager 560 is configurable or configured to transmit the beacon frame that includes one or more target wake time elements indicating a target wake time schedule for the one or more second links, where the one or more second messages are communicated based on the target wake time schedule.

In some examples, the advertisement frame further includes an address indicating at least one of a group address for broadcast communications, an individual address for non-broadcast communications, or a medium access control address of the MLD AP.

In some examples, the advertisement frame indicates, via a group address, one or more STAs including the STA for receipt of the advertisement frame.

In some examples, the advertisement frame or the one or more parameters for the one or more second links is transmitted in one or more delivery traffic indication message beacons in accordance with a periodicity. In some examples, the advertisement frame further indicates the periodicity.

In some examples, the periodicity is in accordance with a first period between each delivery traffic indication message beacon of the one or more delivery traffic indication message beacons or in accordance with a second period between one or more nonconsecutive delivery traffic indication message beacons of the one or more delivery traffic indication message beacons.

In some examples, the link information manager 545 is configurable or configured to receive, via the first link or one or more third links, one or more request frames in accordance with the advertisement frame. In some examples, the link information manager 545 is configurable or configured to transmit, via the first link or one or more third links, one or more response frames indicating at least one of the one or more parameters for the one or more second links or indicating one or more target wake time elements indicating a target wake time schedule for the one or more second links in accordance with the one or more request frames.

In some examples, the link establishment manager 525 is configurable or configured to transmit a link setup message including an indication of the first link or the one or more third links.

In some examples, the advertisement frame further includes one or more target wake time elements indicating a target wake time schedule for the one or more second links or one or more elements carrying parameters for the one or more second links.

In some examples, the advertisement frame is transmitted via the first band based on a traffic condition of a second band satisfying a congestion threshold.

In some examples, the advertisement frame includes one or more containers. In some examples, each container of the one or more containers is indicated in the advertisement frame according to a fixed order. In some examples, each of the one or more containers consists of a field, an element, or both.

In some examples, the neighbor report manager 550 is configurable or configured to transmit a neighbor report or a reduced neighbor report included in the advertisement frame that indicates existence of the one or more second links.

In some examples, the advertisement frame includes at least one of a multi-link operation link information element or a basic multi-link element to indicate the one or more second links.

In some examples, the advertisement frame includes a message integrity check field or at least a portion of the advertisement frame is pairwise encrypted.

In some examples, the beamformed communication manager 555 is configurable or configured to communicate a beamformed communication via the one or more second links.

FIG. 6 shows a flowchart illustrating an example process 600 performable by or at a MLD AP that supports advertising 60 gigahertz link information in sub-7 gigahertz links for IMMW. The operations of the process 600 may be implemented by a MLD AP or its components as described herein. For example, the process 600 may be performed by a wireless communication device, such as the wireless communication device 500 described with reference to FIG. 5, operating as or within a wireless AP. In some examples, the process 600 may be performed by a wireless AP, such as one of the APs 102 described with reference to FIG. 1.

In some examples, in 605, the MLD AP may communicate one or more first messages to establish a first link with a wireless STA, where the first link is an omnidirectional communication link for communication using a first radio access technology. In some implementations, aspects of the operations of 605 may be performed by a link establishment manager 525 as described with reference to FIG. 5.

In some examples, in 610, the MLD AP may transmit, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, where the one or more second bands are shared with one or more second radio access technologies that differ from the first radio access technology. In some implementations, aspects of the operations of 610 may be performed by an advertisement frame manager 530 as described with reference to FIG. 5.

In some examples, in 615, the MLD AP may communicate one or more second messages to establish the one or more second links for communication with the STA based on the advertisement frame and the one or more parameters. In some implementations, aspects of the operations of 615 may be performed by a link establishment manager 525 as described with reference to FIG. 5.

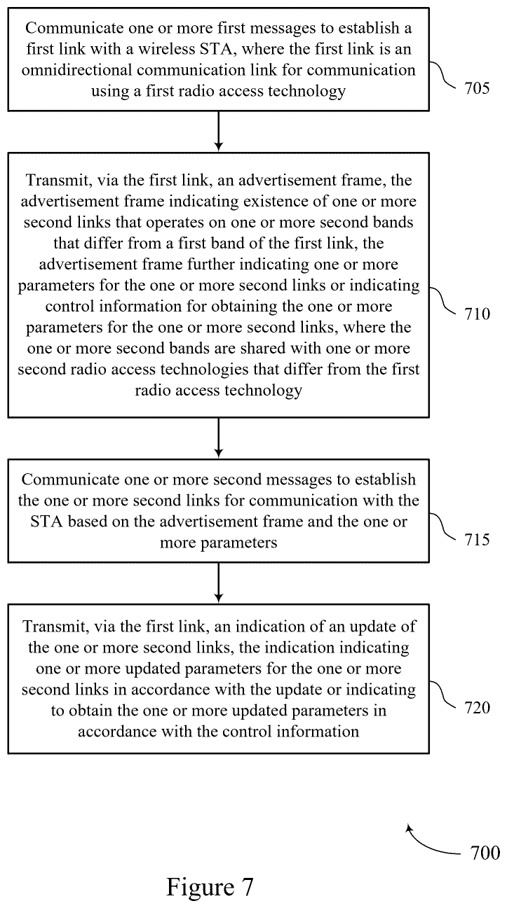

FIG. 7 shows a flowchart illustrating an example process 700 performable by or at a MLD AP that supports advertising 60 gigahertz link information in sub-7 gigahertz links for IMMW. The operations of the process 700 may be implemented by a MLD AP or its components as described herein. For example, the process 700 may be performed by a wireless communication device, such as the wireless communication device 500 described with reference to FIG. 5, operating as or within a wireless AP. In some examples, the process 700 may be performed by a wireless AP, such as one of the APs 102 described with reference to FIG. 1.

In some examples, in 705, the MLD AP may communicate one or more first messages to establish a first link with a wireless STA, where the first link is an omnidirectional communication link for communication using a first radio access technology. In some implementations, aspects of the operations of 705 may be performed by a link establishment manager 525 as described with reference to FIG. 5.

In some examples, in 710, the MLD AP may transmit, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, where the one or more second bands are shared with one or more second radio access technologies that differ from the first radio access technology. In some implementations, aspects of the operations of 710 may be performed by an advertisement frame manager 530 as described with reference to FIG. 5.

In some examples, in 715, the MLD AP may communicate one or more second messages to establish the one or more second links for communication with the STA based on the advertisement frame and the one or more parameters. In some implementations, aspects of the operations of 715 may be performed by a link establishment manager 525 as described with reference to FIG. 5.

In some examples, in 720, the MLD AP may transmit, via the first link, an indication of an update of the one or more second links, the indication indicating one or more updated parameters for the one or more second links in accordance with the update or indicating to obtain the one or more updated parameters in accordance with the control information. In some implementations, aspects of the operations of 720 may be performed by a link update manager 535 as described with reference to FIG. 5.

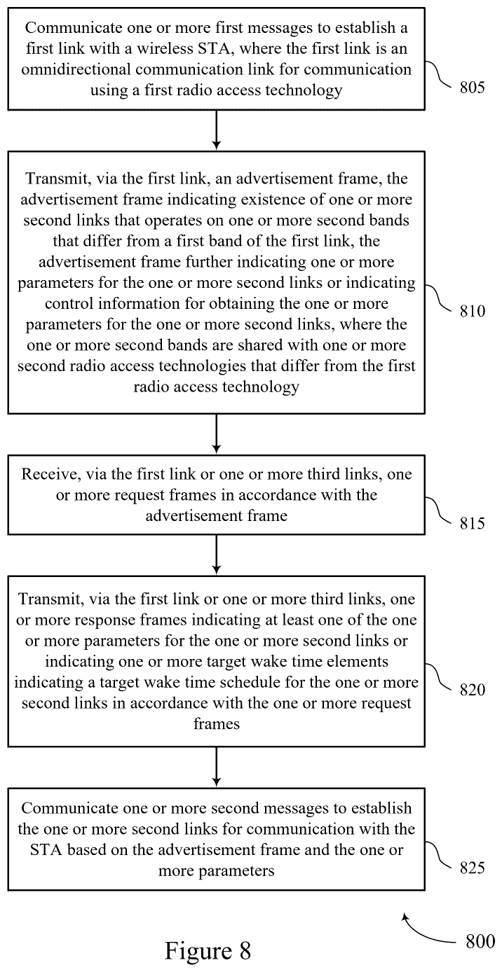

FIG. 8 shows a flowchart illustrating an example process 800 performable by or at a MLD AP that supports advertising 60 gigahertz link information in sub-7 gigahertz links for IMMW. The operations of the process 800 may be implemented by a MLD AP or its components as described herein. For example, the process 800 may be performed by a wireless communication device, such as the wireless communication device 500 described with reference to FIG. 5, operating as or within a wireless AP. In some examples, the process 800 may be performed by a wireless AP, such as one of the APs 102 described with reference to FIG. 1.

In some examples, in 805, the MLD AP may communicate one or more first messages to establish a first link with a wireless STA, where the first link is an omnidirectional communication link for communication using a first radio access technology. In some implementations, aspects of the operations of 805 may be performed by a link establishment manager 525 as described with reference to FIG. 5.

In some examples, in 810, the MLD AP may transmit, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, where the one or more second bands are shared with one or more second radio access technologies that differ from the first radio access technology. In some implementations, aspects of the operations of 810 may be performed by an advertisement frame manager 530 as described with reference to FIG. 5.

In some examples, in 815, the MLD AP may receive, via the first link or one or more third links, one or more request frames in accordance with the advertisement frame. In some implementations, aspects of the operations of 815 may be performed by a link information manager 545 as described with reference to FIG. 5.

In some examples, in 820, the MLD AP may transmit, via the first link or one or more third links, one or more response frames indicating at least one of the one or more parameters for the one or more second links or indicating one or more target wake time elements indicating a target wake time schedule for the one or more second links in accordance with the one or more request frames. In some implementations, aspects of the operations of 820 may be performed by a link information manager 545 as described with reference to FIG. 5.

In some examples, in 825, the MLD AP may communicate one or more second messages to establish the one or more second links for communication with the STA based on the advertisement frame and the one or more parameters. In some implementations, aspects of the operations of 825 may be performed by a link establishment manager 525 as described with reference to FIG. 5.

Implementation examples are described in the following numbered clauses:

Clause 1: A method for wireless communication at a MLD AP, comprising: communicating one or more first messages to establish a first link with a wireless STA, wherein the first link is an omnidirectional communication link for communication using a first radio access technology; transmitting, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, wherein the one or more second bands are shared with one or more second radio access technologies that differ from the first radio access technology; and communicating one or more second messages to establish the one or more second links for communication with the STA based at least in part on the advertisement frame and the one or more parameters.

Clause 2: The method of clause 1, further comprising: transmitting, via the first link, an indication of an update of the one or more second links, the indication indicating one or more updated parameters for the one or more second links in accordance with the update or indicating to obtain the one or more updated parameters in accordance with the control information.

Clause 3: The method of clause 2, wherein the indication of the update of the one or more second links comprises one bit field or multiple bit fields, and wherein a value of the bit field or a combined value of the multiple bit fields indicates the update.

Clause 4: The method of clause 2, wherein the indication of the update of the one or more second links is transmitted via a bacon frame, and wherein the indication of the update of the one or more second links corresponds to an early portion of the beacon frame.

Clause 5: The method of clause 1, further comprising: transmitting, via the first link, a beacon frame indicating the one or more parameters for the one or more second links or indicating the control information for obtaining the one or more parameters for the one or more second links.

Clause 6: The method of clause 5, wherein the beacon frame is transmitted via the first link based at least in part on a size of the beacon frame satisfying a size threshold.

Clause 7: The method of any of clauses 5 through 6, wherein transmitting the beacon frame further comprises: transmitting the beacon frame that comprises one or more TWT elements indicating a TWT schedule for the one or more second links, wherein the one or more second messages are communicated based at least in part on the TWT schedule.

Clause 8: The method of clause 1, wherein the advertisement frame further comprises an address indicating at least one of a group address for broadcast communications, an individual address for non-broadcast communications, or a medium access control address of the MLD AP.

Clause 9: The method of clause 1, wherein the advertisement frame indicates, via a group address, one or more STAs including the STA for receipt of the advertisement frame.

Clause 10: The method of any of clauses 1 through 9, wherein the advertisement frame or the one or more parameters for the one or more second links is transmitted in one or more delivery traffic indication message beacons in accordance with a periodicity, and the advertisement frame further indicates the periodicity.

Clause 11: The method of clause 10, wherein the periodicity is in accordance with a first period between each delivery traffic indication message beacon of the one or more delivery traffic indication message beacons or in accordance with a second period between one or more nonconsecutive delivery traffic indication message beacons of the one or more delivery traffic indication message beacons.

Clause 12: The method of any of clauses 1 through 11, further comprising: receiving, via the first link or one or more third links, one or more request frames in accordance with the advertisement frame; and transmitting, via the first link or one or more third links, one or more response frames indicating at least one of the one or more parameters for the one or more second links or indicating one or more TWT elements indicating a TWT schedule for the one or more second links in accordance with the one or more request frames.

Clause 13: The method of clause 12, further comprising: transmitting a link setup message comprising an indication of the first link or the one or more third links.

Clause 14: The method of any of clauses 1 through 13, wherein the advertisement frame further comprises one or more TWT elements indicating a TWT schedule for the one or more second links or one or more elements carrying parameters for the one or more second links.

Clause 15: The method of any of clauses 1 through 14, wherein the advertisement frame is transmitted via the first band based at least in part on a traffic condition of a second band satisfying a congestion threshold.

Clause 16: The method of any of clauses 1 through 15, wherein the advertisement frame comprises one or more containers, each container of the one or more containers is indicated in the advertisement frame according to a fixed order; and each of the one or more containers consists of a field, an element, or both.

Clause 17: The method of any of clauses 1 through 16, further comprising: transmitting a NR or a RNR included in the advertisement frame that indicates existence of the one or more second links.

Clause 18: The method of any of clauses 1 through 17, wherein the advertisement frame comprises at least one of a MLO link information element or a basic ML element to indicate the one or more second links.

Clause 19: The method of any of clauses 1 through 18, wherein the advertisement frame comprises a MIC field or at least a portion of the advertisement frame is pairwise encrypted.

Clause 20: The method of any of clauses 1 through 19, further comprising: communicating a beamformed communication via the one or more second links.

Clause 21: A MLD AP for wireless communication, comprising a processing system that includes processor circuitry and memory circuitry that stores code, the processing system configured to cause the ML device (MLD) AP to perform a method of any of clauses 1 through 20.

Clause 22: A MLD AP for wireless communication, comprising at least one means for performing a method of any of clauses 1 through 20.

Clause 23: A non-transitory computer-readable medium storing code for wireless communication, the code comprising instructions executable by one or more processors to perform a method of any of clauses 1 through 20.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, “satisfying a threshold” may, depending on the context, refer to a value being greater than the threshold, greater than or equal to the threshold, less than the threshold, less than or equal to the threshold, equal to the threshold, not equal to the threshold, or the like

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A multi-link device (MLD) access point (AP), comprising:
a processing system that includes processor circuitry and memory circuitry that stores code, the processing system configured to cause the MLD AP to:
communicate one or more first messages to establish a first link with a wireless station (STA), wherein the first link is an omnidirectional communication link for communication using a first radio access technology;
transmit, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, wherein the one or more second bands are shared with one or more second radio access technologies that differ from the first radio access technology; and
communicate one or more second messages to establish the one or more second links for communication with the STA based at least in part on the advertisement frame and the one or more parameters.

2. The MLD AP of claim 1, wherein the processing system is further configured to cause the MLD AP to:
transmit, via the first link, an indication of an update of the one or more second links, the indication indicating one or more updated parameters for the one or more second links in accordance with the update or indicating to obtain the one or more updated parameters in accordance with the control information.

3. The MLD AP of claim 1, wherein the processing system is further configured to cause the MLD AP to:
transmit, via the first link, a beacon frame indicating the one or more parameters for the one or more second links or indicating the control information for obtaining the one or more parameters for the one or more second links.

4. The MLD AP of claim 3, wherein the beacon frame is transmitted via the first link based at least in part on a size of the beacon frame satisfying a size threshold.

5. The MLD AP of claim 3, wherein, to transmit the beacon frame, the processing system is further configured to cause the MLD AP to:
transmit the beacon frame that comprises one or more target wake time elements indicating a target wake time schedule for the one or more second links, wherein the one or more second messages are communicated based at least in part on the target wake time schedule.

6. The MLD AP of claim 1, wherein the advertisement frame further comprises an address indicating at least one of a group address for broadcast communications, an individual address for non-broadcast communications, or a medium access control address of the MLD AP.

7. The MLD AP of claim 1, wherein the advertisement frame indicates, via a group address, one or more STAs including the STA for receipt of the advertisement frame.

8. The MLD AP of claim 1, wherein:
the advertisement frame or the one or more parameters for the one or more second links is transmitted in one or more delivery traffic indication message beacons in accordance with a periodicity, and
the advertisement frame further indicates the periodicity.

9. The MLD AP of claim 8, wherein the periodicity is in accordance with a first period between each delivery traffic indication message beacon of the one or more delivery traffic indication message beacons or in accordance with a second period between one or more nonconsecutive delivery traffic indication message beacons of the one or more delivery traffic indication message beacons.

10. The MLD AP of claim 1, wherein the processing system is further configured to cause the MLD AP to:
receive, via the first link or one or more third links, one or more request frames in accordance with the advertisement frame; and
transmit, via the first link or one or more third links, one or more response frames indicating at least one of the one or more parameters for the one or more second links or indicating one or more target wake time elements indicating a target wake time schedule for the one or more second links in accordance with the one or more request frames.

11. The MLD AP of claim 10, wherein the processing system is further configured to cause the MLD AP to:
transmit a link setup message comprising an indication of the first link or the one or more third links.

12. The MLD AP of claim 1, wherein the advertisement frame further comprises one or more target wake time elements indicating a target wake time schedule for the one or more second links or one or more elements carrying parameters for the one or more second links.

13. The MLD AP of claim 1, wherein the advertisement frame is transmitted via the first band based at least in part on a traffic condition of a second band satisfying a congestion threshold.

14. The MLD AP of claim 1, wherein:
the advertisement frame comprises one or more containers,
each container of the one or more containers is indicated in the advertisement frame according to a fixed order; and
each of the one or more containers consists of a field, an element, or both.

15. The MLD AP of claim 1, wherein the processing system is further configured to cause the MLD AP to:
transmit a neighbor report or a reduced neighbor report included in the advertisement frame that indicates existence of the one or more second links.

16. The MLD AP of claim 1, wherein the advertisement frame comprises at least one of a multi-link operation link information element or a basic multi-link element to indicate the one or more second links.

17. The MLD AP of claim 1, wherein the advertisement frame comprises a message integrity check field or at least a portion of the advertisement frame is pairwise encrypted.

18. The MLD AP of claim 1, wherein the processing system is further configured to cause the MLD AP to:
communicate a beamformed communication via the one or more second links.

19. A method for wireless communication at a multi-link device (MLD) access point (AP), comprising:
communicating one or more first messages to establish a first link with a wireless station (STA), wherein the first link is an omnidirectional communication link for communication using a first radio access technology;
transmitting, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, wherein the one or more second bands are shared with one or more second radio access technologies that differ from the first radio access technology; and
communicating one or more second messages to establish the one or more second links for communication with the STA based at least in part on the advertisement frame and the one or more parameters.

20. A non-transitory computer-readable medium storing code for wireless communication, the code comprising instructions executable by one or more processors to:
communicate one or more first messages to establish a first link with a wireless station (STA), wherein the first link is an omnidirectional communication link for communication using a first radio access technology;
transmit, via the first link, an advertisement frame, the advertisement frame indicating existence of one or more second links that operates on one or more second bands that differ from a first band of the first link, the advertisement frame further indicating one or more parameters for the one or more second links or indicating control information for obtaining the one or more parameters for the one or more second links, wherein the one or more second bands are shared with one or more second radio access technologies that differ from the first radio access technology; and
communicate one or more second messages to establish the one or more second links for communication with the STA based at least in part on the advertisement frame and the one or more parameters.
